(19) United States
(12) Patent Application Publication
(10) Pub. No.: US 2025/0312236 A1
(43) Pub. Date: Oct. 9, 2025

(54) CPR CHEST COMPRESSION DEVICE WITH STOPPER FOR RELEASABLE BASE MEMBER

(71) Applicant: STRYKER CORPORATION, Portage, MI (US)

(72) Inventors: Wiktor Kocula, Löderup (SE); Daniel Keiser Lagesson, Malmö (SE); Marcus Ehrstedt, Kävlinge (SE)

(73) Assignee: STRYKER CORPORATION, Portage, MI (US)

(21) Appl. No.: 19/098,896

(22) Filed: Apr. 2, 2025

Related U.S. Application Data
(60) Provisional application No. 63/574,822, filed on Apr. 4, 2024.

(51) Int. Cl. A61H 31/00

(52) U.S. Cl. CPC A61H 31/006; A61H 2031/001; A61H 2201/1207

(57) ABSTRACT

A cardiopulmonary resuscitation (“CPR”) device has a clamp mechanism coupled with a support leg, structured to move between an unlocked position and a locked position to secure the support leg to a locking rod of a base member. The CPR device further includes a movable stopper comprising a strip-formed spring slidably coupled with the support leg and configured to translate between a barred position and an unbarred position relative to the clamp mechanism, the movable stopper preventing the locking rod from being received in the receiving channel of the when the movable stopper is in the barred position, and the movable stopper allowing the locking rod to be received in the receiving channel when the movable stopper is in the unbarred position, the movable stopper further receiving the pin of the barrel in a slot when the movable stopper is in the unbarred position.

### PRIORITY

This disclosure claims the benefit of U.S. Provisional Application No. 63/574,822, filed on Apr. 4, 2024, which is incorporated herein by reference in its entirety.

### TECHNICAL FIELD

The subject matter is related to CPR devices that deliver CPR chest compressions to a patient, and, more particularly, to a system and methods for assembling such CPR devices.

### BACKGROUND

Cardiopulmonary resuscitation (CPR) is a medical procedure performed on patients to maintain some level of circulatory and respiratory functions when patients otherwise have limited or no circulatory and respiratory functions. CPR is generally not a procedure that restarts circulatory and respiratory functions, but can be effective to preserve enough circulatory and respiratory functions for a patient to survive until the patient's own circulatory and respiratory functions are restored. CPR typically includes frequent torso compressions that usually are performed by pushing on or around the patient's sternum while the patient is lying on the patient's back. For example, torso compressions can be performed as at a rate of about 100 compressions per minute and at a depth of about 5 cm per compression for an adult patient. The frequency and depth of compressions can vary based on a number of factors, such as valid CPR guidelines.

Mechanical CPR has several advantages over manual CPR. A person performing CPR, such as a medical first-responder, must exert considerable physical effort to maintain proper compression timing and depth. Over time, fatigue can set in and compressions can become less consistent and less effective. The person performing CPR must also divert mental attention to performing manual CPR properly and may not be able to focus on other tasks that could help the patient. For example, a person performing CPR at a rate of 100 compressions per minute would likely not be able to simultaneously prepare a defibrillator for use to attempt to correct the patient's heart rhythm. Mechanical compression devices can be used with CPR to perform compressions that would otherwise be done manually. Mechanical compression devices can provide advantages such as providing constant, proper compressions for sustained lengths of time without fatiguing, freeing medical personnel to perform other tasks besides CPR compressions, and being usable in smaller spaces than would be required by a person performing CPR compressions.

Some mechanical CPR devices may have structures that can be assembled and disassembled. During a CPR event, it is desirable to assemble such CPR devices quickly, as any time spent on tasks other than performing CPR may hinder preserving the patient's respiratory and circulatory functions.

Configurations of the disclosed technology address shortcomings in the prior art.

### BRIEF DESCRIPTION OF THE DRAWINGS

FIG. 1 is a perspective view of a CPR device, according to an example configuration.

FIG. 2 is a front view of the CPR device of FIG. 1, also showing a representation of a patient within the CPR device.

FIG. 3 is a perspective view of a clamp mechanism for a CPR device in a first, unlocked position, according to an example configuration

FIG. 4 is a perspective view of the clamp mechanism of FIG. 3 in a second, locked position.

FIG. 5 is a side view of the clamp mechanism of FIG. 3 in the unlocked position.

FIG. 6 is a side view of the clamp mechanism of FIG. 3 in the unlocked position, also showing further internal details of the CPR device.

FIG. 7 is a side view of the clamp mechanism of FIG. 3 in the locked position, also showing further internal details of the CPR device.

FIG. 8 is a perspective view of a clamp mechanism for a CPR device in a first unlocked position, according to an additional example configuration.

FIG. 9 is a perspective view of the clamp mechanism of FIG. 8 in a second, locked position.

FIG. 10 is a side view of the clamp mechanism of FIG. 8 in the unlocked position.

FIG. 11 is a side view of the clamp mechanism of FIG. 8 in the unlocked position, also showing further internal details of the CPR device.

FIG. 12 is a side view of the clamp mechanism of FIG. 8 in the locked position, also showing further internal details of the CPR device.

FIG. 13 is a perspective view of a stopper for a clamp mechanism, according to an additional example configuration.

FIG. 14 is a perspective view of a clamp mechanism implementing the stopper of FIG. 13, according to an example configuration.

FIG. 15 is a partially exploded view of the clamp mechanism of FIG. 14, showing further details of the clamp mechanism.

### DETAILED DESCRIPTION

As described herein, aspects are directed to a cardiopulmonary resuscitation (“CPR”) device having a support leg that may be always lockable to the base member. The support leg is configured to support the chest compression mechanism away from the base member, which is configured to be placed underneath a patient during operation of the CPR device. The support leg, in configurations, also positions the chest compression mechanism over the patient's chest to deliver CPR chest compressions to a patient. As mentioned, the support leg of the CPR device may be “always lockable,” meaning that the mechanism for locking the support leg to the base member need not be reset or unlatched before attaching it to the base member. Rather, when the support leg is not attached, it is always in a position ready to be locked to the base member. This feature may make the CPR device easier to use, especially in emergency situations where there may be a therapeutic benefit to the patient if the CPR device can be quickly and properly assembled and positioned for use.

In particular, configurations of the disclosed technology provide a rotatable claw mechanism for engaging with and attaching to an axle of the base member, and configurations provide a stopper for keeping the rotatable claw mechanism lockable until the claw mechanism engages with the base member. For purposes of this disclosure, “to engage” means to interlock with; to fit together. Prior devices without such a stopper have presented difficulties in situations where the locking mechanism of the support leg was unintentionally locked. For example, such prior devices may have accidentally bumped into an object or the floor, causing the locking mechanism to rotate and enter the locked position. When accidentally locked in this way, prior devices required unlocking or resetting the locking mechanism to then properly secure the support leg to the base member. In contrast, configurations of the disclosed rotatable claw mechanism do not enter the locked position unless engaging with the axle of the base member to which the rotatable claw mechanism is meant to be attached.

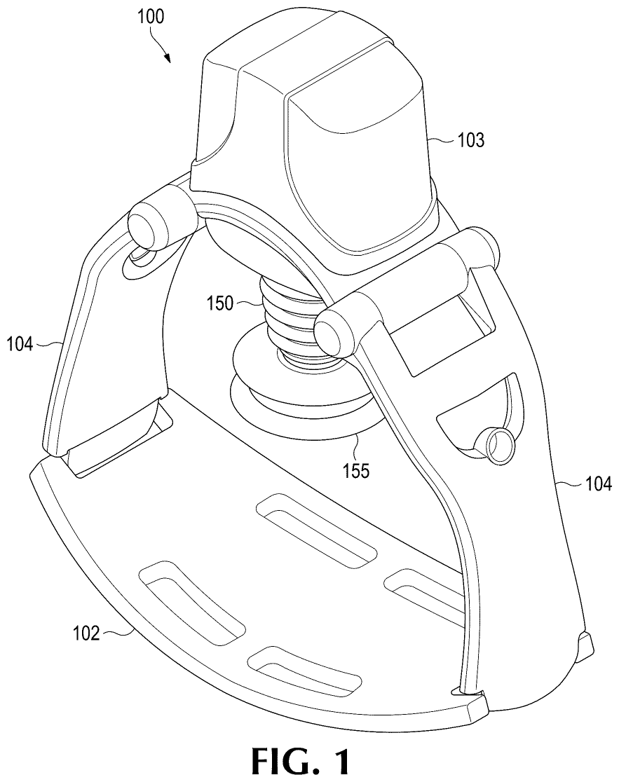

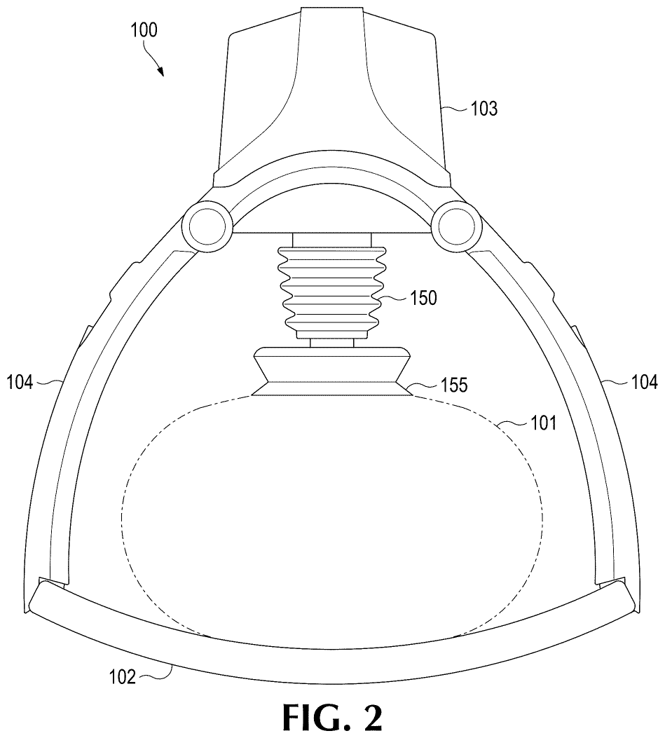

FIG. 1 is a perspective view showing portions of a CPR device 100, according to configurations. FIG. 2 is a front view of the CPR device 100 of FIG. 1, also showing a representation of a patient 101 within the CPR device 100. As illustrated in FIGS. 1 and 2, a CPR device 100 has a base member 102, a chest compression mechanism 103, and a support leg 104.

The chest compression mechanism 103 is configured to deliver CPR chest compressions to the patient 101. The chest compression mechanism 103, in example configurations, includes a motor-driven piston 150 configured to contact the patient's chest to provide the CPR chest compressions. In additional or alternative configurations, the motor-driven piston 150 includes a suction cup 155.

The support leg 104 shown in FIG. 1 is configured to support the chest compression mechanism 103 at a distance from the base member 102. For example, if the base member 102 is underneath the patient 101, who is lying on the patient's back, then the support leg 104 supports the chest compression mechanism 103 at a sufficient distance over the base member 102 to allow the patient 101 to lay within a space between the base member 102 and the chest compression mechanism 103, while positioning the chest compression mechanism 103 over the patient's chest.

In configurations, two support legs 104 are provided. In configurations, the two support legs 104 together form an arch to support the chest compression mechanism 103. An example of such a configuration is illustrated in FIGS. 1-2.

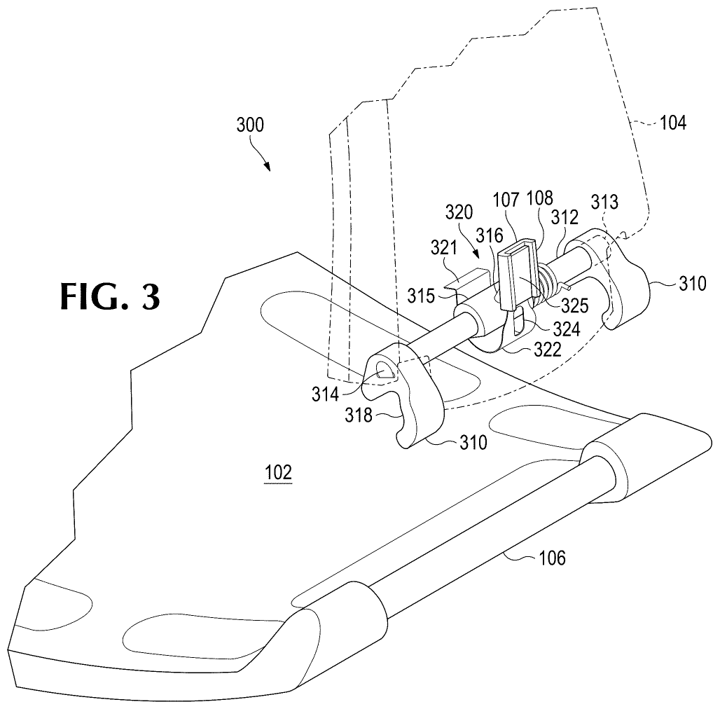

FIG. 3 is a cutaway, perspective view of a CPR device, such as the example shown in FIGS. 1-2, showing details of a rotatable claw mechanism 300 implemented with a base member 102 and support leg 104 in an unlocked position. The base member 102 is configured to be placed underneath the patient, as shown in FIG. 2, with the patient lying on their back. As shown in FIG. 3, the base member 102 has a locking rod 106 at which the rotatable claw mechanism 300 can be attached. As shown, the locking rod 106 is at an end of the base member 102 at which support leg 104 meets and engages with the base member 102. Although not illustrated in FIG. 3, in example configurations implementing two support legs, the base member 102 has two locking rods, each located at an end of the base member 102 where the base member 102 meets and engages with a support leg.

The rotatable claw mechanism 300 may be coupled with the support leg 104, described in further detail below, allowing the rotatable claw mechanism 300 to be the point of interface between the support leg 104 and base member 102. As shown, the rotatable claw mechanism 300 has one or more claws 310 positioned on an axle 312, such that the one or more claws 310 rotate with the axle 312. In configurations, such as the example shown in FIG. 3, the rotatable claw mechanism 300 has two claws 310, positioned at ends 313, 314 of the axle 312, respectively. In configurations having two claws 310, each claw 310 is positioned on axle 312 such that the claws 310 rotate with the axle 312. Additionally, axle 312 has a barrel 315 with a pin 316 extending from a surface of the barrel 315. Because of the curved shape of claws 310, a receiving channel 318 is formed. This receiving channel 318 comprises the space within the curvature of the claws 310, and it can be imagined to extend from end 313 of axle 312 to end 314, parallel to axle 312. The receiving channel 318 is thus shaped to receive the locking rod 106 when the support leg 104 and base member 102 are coupled.

The rotatable claw mechanism 300 is configured to attach the support leg 104 to the locking rod 106 of the base member 102, in configurations. For example, locking rod 106 can be received in the receiving channel 318 of the claws 310, and the claws 310 rotate with axle 312 such that claws 310 wrap around the locking rod 106 and secure the support leg 104 to the base member 102. In example configurations, the support leg 104 also includes a release mechanism, described in further detail below, to release the support leg 104 from the locking rod 106 and thus separate the support leg 104 from the base member 102.

As mentioned, prior CPR devices implemented mechanisms vulnerable to accidental deployment. In other words, mechanisms similar to the claw mechanism described above may have accidentally been bumped against an object or the ground, causing the mechanism to move to a locked position despite not being in engagement with the base member. In configurations of the disclosed technology, however, a stopper is provided to ensure the claw mechanism enters a locked position only when in engagement with the locking rod of the base member.

FIG. 3 illustrates a stopper 320 for implementation with rotatable claw mechanism 300. As shown, stopper 320 has a tab 321, a curved portion 322, and an elongated portion 323, such that stopper 320 is substantially J-shaped. Stopper 320 also has a slot 324, which is cut from the material forming the stopper 320, in example configurations. The slot 324 is shaped to receive the pin 316 of the rotatable claw mechanism 300 in the locked position, described in further detail below. Alternatively, in configurations, a channel or recess could be formed in the material of the stopper 320. In configurations, a hole, opening, or gap is instead formed. The curved portion 322 of the stopper 320, as shown in FIG. 3, fits around the barrel 315 of the rotatable claw mechanism 300 but does not directly contact the barrel 315 when the rotatable claw mechanism 300 is in an unlocked position. Although not illustrated in FIG. 3, the tab 321 of the stopper 320 can be fixed, in configurations, to a portion of the support leg 104. Stopper 320, in configurations, also has a slider 325 attached to the elongated portion 323. The slider 325 is structured to slidably couple with a receiver 107 of the rotatable claw mechanism 300 having a track 108, such that the slider 325 translates up and down within the track 108.

Stopper 320, in the example illustrated in FIG. 3, is formed of a single, thin strip of a compliant sheet metal, such as steel. In this way, a strip is cut from the sheet metal, and in configurations, slot 324 is cut from the strip. The strip is then bent to form the J-shape of stopper 320, and can be bent again to create tab 321. Because the stopper 320 is formed to have a curved portion 322 and is made from compliant sheet metal, stopper 320 thus acts as a strip-formed spring. Put differently, when a stopper 320 is fixed at one end and a force is applied, a portion of the stopper 320 will displace and cause the stopper 320 to have potential energy. When the force is no longer applied, the potential energy will cause the stopper 320 to return to its original position before being displaced by the force.

In configurations, the thickness of stopper 320 is no more than 10% the width of the strip. In configurations, and more preferably, the thickness of stopper 320 is no more than 5% the width of the strip. In still other configurations, the thickness of stopper 320 is no more than 1% or 0.1% the width of the strip.

Referring back to FIG. 3, the rotatable claw mechanism 300 is shown in the unlocked position. For purposes of this disclosure, the rotatable claw mechanism 300 is in the unlocked position when the locking rod 106 of the base member 102 is not received in the receiving channel 318, and the claws 310 have thus not rotated to fit around the locking rod 106. Additionally, in the unlocked position, the curved portion 322 of stopper 320 extends into the receiving channel 318. In this way, when the support leg 104 is moved toward the locking rod 106 of the base member 102, the locking rod 106 will enter the receiving channel 318 and contact the curved portion 322 of the stopper 320. Applying a force will then move the stopper 320 and allow the claws 310 to rotate around the locking rod 106, locking the rotatable claw mechanism 300 and securing the support leg 104 to the base member 102. This locking motion is described in further detail below.

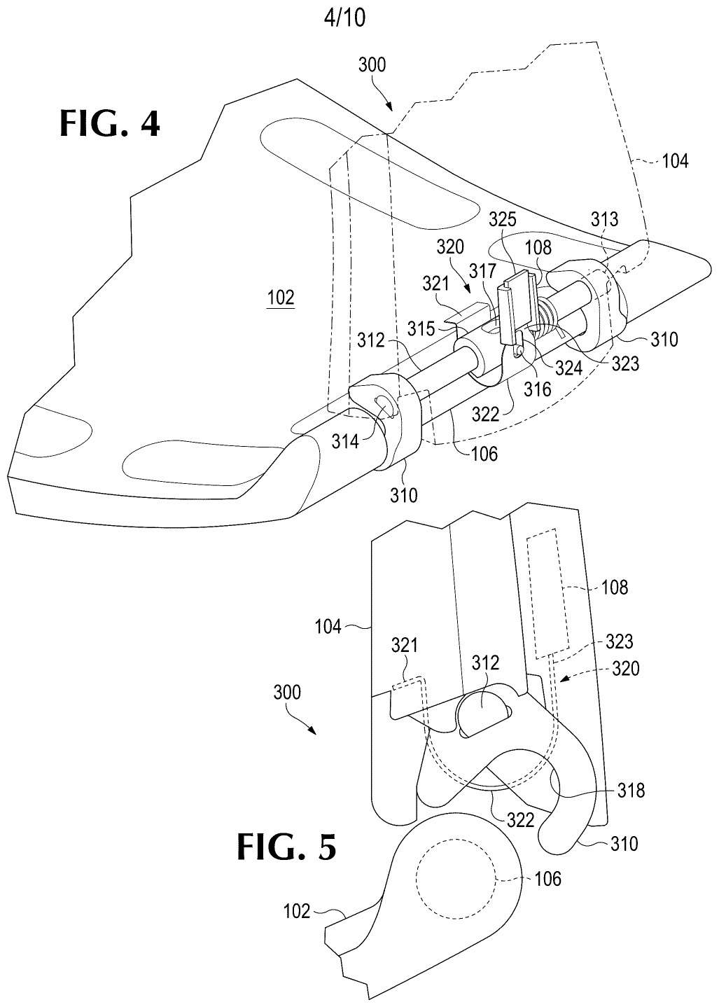

FIG. 4 is a cutaway, perspective view showing the rotatable claw mechanism 300 in the locked position, coupling the support leg 104 with the base member 102. As shown, in the locked position, the locking rod 106 is fully received in the receiving channel 318—not shown in FIG. 4, as the channel is occupied by the locking rod 106—and the axle 312 of the rotatable claw mechanism 300 has rotated in a clockwise direction. It should be noted that reference to the clockwise direction is used as an example, with specific regard to the orientation depicted in FIG. 4. Reference to the clockwise direction thus should not be understood as limiting the rotational direction of the axle 312 in any way. Indeed, in a CPR device utilizing two support legs 104 forming an arch, a rotatable claw mechanism 300 can be implemented on each support leg 104, and one rotatable claw mechanism 300 rotates clockwise while the other rotates counterclockwise in order to lock to the base member 102.

When the axle 312 has rotated to enter the locked position, the claws 310 rotate with the axle 312 and around the locking rod 106. In this way, the claws 310 substantially surround the locking rod 106 in the locked position. For the purposes of this disclosure, “substantially surround” means largely or essentially extending around, without requiring perfect encircling. Furthermore, as shown in FIG. 4, the barrel 315 of the rotatable claw mechanism 300 has rotated with the axle 312 to the locked position. When the barrel 315 has rotated to the locked position, the pin 316 also rotates with the barrel, and the pin 316 fits within slot 324 of the stopper 320. The rotation of the barrel 315 to the locked position also exposes a recess 317 in the barrel 315. As shown, in the locked position, the recess 317 faces a direction along length of the support leg 104. As will be described further below, the recess 317 is thus positioned to receive an extension of a linking rod within the support leg 104. Finally, in the locked position, the stopper 320 is moved sufficiently away from its position in the receiving channel of the rotatable claw mechanism 300 such that the locking rod 106 occupies the receiving channel.

FIG. 5 shows a side view of the rotatable claw mechanism 300 of FIGS. 3-4, in the unlocked position. As mentioned, and as shown in more detail in FIG. 5, the curved portion 322 of the stopper 320 extends into the receiving channel 318. In this way, when the support leg 104 is moved toward the locking rod 106 of the base member 102, the locking rod 106 will enter the receiving channel 318 and contact the curved portion 322 of the stopper 320.

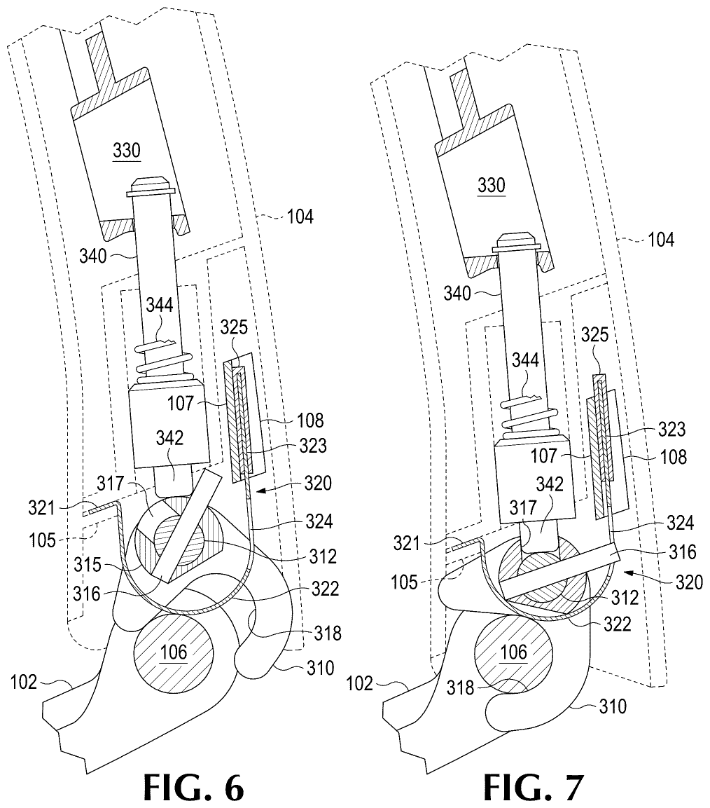

FIGS. 6-7 show the rotatable claw mechanism 300 of FIGS. 3-5 transitioning from the unlocked position to the locked position, further including internal components of the support leg 104. FIG. 6 shows the rotatable claw mechanism 300 initially in the unlocked position. As shown, rotatable claw mechanism includes a pull rod 330 and a linking rod 340. Each of the pull rod 330 and linking rod 340 are positioned within the support leg 104 and extend along the length of the support leg 104. The pull rod 330 is coupled with the linking rod 340 such that they translate together along the length of the support leg 104. Additionally, linking rod 340 includes an extension 342 and a biasing spring 344. The biasing spring 344 works to bias the linking rod 340 toward the claw mechanism—specifically, toward the barrel 315.

In the unlocked position, extension 342 of the linking rod 340 thus rests against the outer surface of the barrel 315. As shown, the barrel 315 is positioned such that the recess 317 is not exposed to the extension 342, and the recess 317 accordingly does not receive the extension 342. Similarly, in the unlocked position, roll pin 316 is not received in the slot 324 of the stopper 320. In configurations, roll pin 316 rests against the elongated portion 323 of the stopper 320 directly above the slot 324, restricting any movement of the barrel 315. Furthermore, in the unlocked position, locking rod 106 of the base member 102 is not fully received in the receiving channel 318, and the curved portion 322 of the stopper 320 extends into the receiving channel 318.

As mentioned, stopper 320 is shaped to have a tab 321. The tab 321, as shown in FIG. 6, is fixed to an internal portion of the support leg 104, in configurations. In particular, the tab 321 is fixed to a ledge 105 extending from an internal surface of the wall forming the support leg 104. The ledge is thus shaped to have a substantially flat surface for interfacing with the substantially flat sheet metal forming the tab 321. For purposes of this disclosure, “substantially flat” means largely or essentially level and even in surface, without requiring perfect evenness. The elongated portion 323 of the stopper 320, conversely, is movable and not fixed. More specifically, the elongated portion 323 has a slider 325 positioned in a track 108 of a receiver 107 of the support leg 104. The track 108, in configurations, is shaped to interface with and limit two sides of the slider 325—namely, the sides along the length of the elongated portion—such that the slider 325 and the elongated portion 323 are limited to translation with one degree of freedom within the receiver 107. Put differently, the elongated portion 323 and slider 325 of the stopper 320 fit within the receiver 107 such that they slide in a direction along the length of the support leg 104. Although receiver 107 is illustrated in FIG. 6 internally within the support leg 104, in configurations, receiver 107 is formed on an external surface of the support leg 104.

As shown in FIG. 6, although the rotatable claw mechanism is in the unlocked position, the locking rod 106 is in contact with the stopper 320 to begin transitioning the mechanism from the unlocked position to the locked position. Because the stopper 320 is fixed at the tab 321 and structured to translate, and because the stopper 320 is structured to be a strip-formed spring, applying a force against the curved portion 322 of the stopper 320 causes all portions of the stopper 320 excluding the tab 321 to translate away from the shown position in FIG. 6. Specifically, the stopper 320 translates within the sliding channel 107 due to the positioning of the elongated portion 323 within the sliding channel 107, and the curved portion 322 deflects away from the receiving channel 318 due to the resiliency of the stopper 320. In this way, the locking rod 106 contacting the stopper 320 facilitates the force being applied and transitioning the mechanism to the locked position. For instance, a rescuer assembling the CPR device may position the base member 102 beneath a patient, with the patient laying supine. The rescuer may then assemble the rest of the CPR device around the patient, pressing a support leg 104—such as the example illustrated in FIG. 6—onto the base member 102. Accordingly, the rescuer may apply the necessary force to cause the stopper 320 to translate within the sliding channel 107 by pressing the stopper 320 against the locking rod 106.

When the stopper 320 is pressed against the locking rod 106, the rotatable claw mechanism transitions to the locked position, shown in FIG. 7. Specifically, pressing the stopper 320 against the locking rod 106 causes the elongated portion 323 and slider 325 of the stopper 320 to translate upward along the length of the support leg 104. As the elongated portion 323 translates upward, the slot 324 also translates upward, as the elongated portion 323 and slot 324 move together as portions of the entire stopper 320. Additionally, because of the spring-like structure of the stopper 320, the curved portion 322 of the stopper 320 deflects out of the receiving channel 318 and thus out of the way of the locking rod 106. The locking rod 106, in the locked position, therefore occupies the space of the receiving channel 318 and is substantially surrounded by claws 310.

As previously discussed, in the unlocked position, roll pin 316 rests against the elongated portion 323 of the stopper 320 and restricts movement of the barrel 315 and axle 312, in configurations. Consequently, when the elongated portion 323 translates upward along the length of the support leg 104, the slot 324 also translates upward, allowing the roll pin 316 to drop into the slot 324. Allowing the roll pin 316 to drop into the slot 324 in this way ultimately permits the barrel 315 and axle 312 to rotate and transition the mechanism from the unlocked position to the locked position. Once barrel 315 is free to rotate clockwise, barrel 315 rotates sufficiently to expose the recess 317 to the extension 342 of the linking rod 340. Because the linking rod 340 is biased toward the barrel 315 by biasing spring 344, the extension 342 of the linking rod 340 drops into the recess 317 when the recess 317 is exposed. Consequently, in the locked position, the extension 342 fits within the recess 317 and is biased in this position by the biasing spring 344.

Furthermore, when the axle 312 is free to rotate, the claws 310 rotate with the axle 312. Accordingly, as axle 312 rotates such that roll pin 316 drops into the slot 324, claws 310 rotate to substantially surround locking rod 106 of the base member 102. With the claws 310 substantially surrounding the locking rod 106, the support leg 104 and base member 102 are coupled in the locked position.

To release the support leg 104 and base member 102 from their coupling in the locked position, a rescuer may pull the pull rod 330. Although not illustrated in FIG. 7, in configurations, pull rod 330 has a pull ring at an end opposite the linking rod 340, and the pull ring is external to the support leg 104 and thus accessible to the rescuer. In still other configurations, pull rod 330 has a tab, handle, or other suitable extension accessible to the rescuer and structured to pull the pull rod 330 along the length of the support leg 104 in a direction away from the base member 102. When pull rod 330 is pulled in such a direction, linking rod 340 translates with the pull rod 330 away from the base member 102. As linking rod 340 translates, the extension 342 lifts out of its position within the recess 317, freeing the barrel 315 to rotate.

Because stopper 320 is structured as a strip-formed spring, stopper 320 is biased toward the unlocked position, where the stopper 320 is not displaced. Accordingly, when extension 342 lifts out of recess 317 and frees barrel 315 to rotate, stopper 320 tends to spring back toward its unlocked position, and the slot 324 and elongated portion 323 translate downward. As the slot 324 translates downward, roll pin 316 exits its position within slot 324. In configurations, barrel 315 and axle 312 are also biased toward the unlocked position, and thus, freeing the roll pin 316 from the slot 324 and freeing the barrel 315 to rotate causes barrel 315 and axle 312 to rotate counterclockwise to the unlocked position. As axle 312 rotates counterclockwise, claws 310 also rotate counterclockwise and accordingly release the locking rod 106 of the base member. With locking rod 106 no longer surrounded by claws 310, the support leg 104 can be lifted from the base member 102, returning the mechanism to the unlocked position, as described with regard to FIG. 6.

Because the rotatable claw mechanism of FIGS. 3-6 is deployed by pushing the locking rod 106 against stopper 320, the rotatable claw mechanism may be considered always lockable from the unlocked position. Put differently, in the unlocked position, the rotatable claw mechanism can be deployed and locked without the rescuer needing to unlatch or reset any components of the mechanism. Rather, the rescuer need only apply a force to deploy the rotatable claw mechanism 300. However, because the stopper 320 must be contacted and moved to allow the mechanism to lock, accidentally bumping the claws 310 on the ground or another object will not cause the rotatable claw mechanism 300 to deploy. Instead, the mechanism will only deploy when the stopper 320 is brought into contact with the locking rod 106. In this way, the rotatable claw mechanism 300 is always lockable but is not vulnerable to inadvertent locking, which could lead to wasted time in a rescue scenario having to unlock the mechanism.

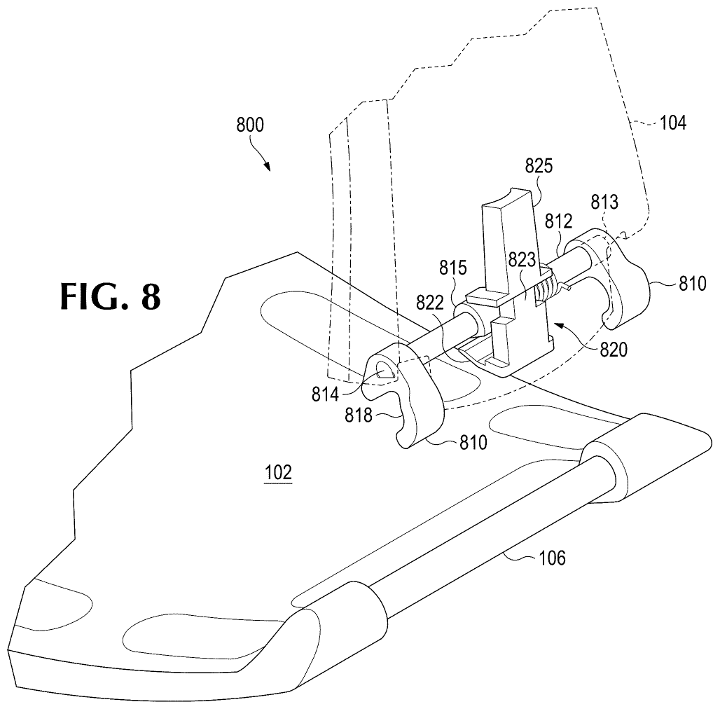

FIG. 8 is a cutaway, perspective view of a CPR device, such as the example shown in FIGS. 1-2, showing details of a rotatable claw mechanism 800 in an unlocked position, according to configurations. The rotatable claw mechanism 800, similar to the example described with regard to FIGS. 3-7, is implemented with a base member 102 and support leg 104. The base member 102 is configured to be placed underneath the patient, as shown in FIG. 2, with the patient lying on their back. As shown in FIG. 8, the base member 102 includes a locking rod 106 at which the rotatable claw mechanism 800 is attached. The locking rod 106 is at an end of the base member 102 at which support leg 104 meets and engages with the base member 102. Although not illustrated in FIG. 8, in configurations of the CPR device implementing two support legs, the base member 102 has two locking rods, each located at an end of the base member 102 where the base member 102 meets and engages with a support leg.

Just as described with regard to FIGS. 3-7, the rotatable claw mechanism 800 of FIG. 8 can be coupled with the support leg 104, allowing the rotatable claw mechanism 800 to be the point of interface between the support leg 104 and the base member 102. As shown, the rotatable claw mechanism 800 has one or more claws 810 positioned on an axle 812, such that the one or more claws 810 rotate with the axle 812. In configurations, such as the example shown in FIG. 8, the rotatable claw mechanism 800 has two claws 810, positioned at ends 813, 814 of the axle 812 such that each of the claws 810 rotate with the axle 812. Additionally, axle 812 has a barrel 815, which rotates with the axle 812. As discussed with regard to the example mechanism illustrated in FIGS. 3-7, the curved shape of claws 810 in the rotatable claw mechanism 800 form a receiving channel 818. This receiving channel 818 is shaped to receive the locking rod 106 when the support leg 104 and base member 102 are coupled.

The rotatable claw mechanism 800 is configured to attach the support leg 104 to the locking rod 106 of the base member 102, in a similar manner as just described with regard to FIGS. 3-7. For example, locking rod 106 is received in the receiving channel 818 of the claws 810, and the claws 810 rotate with axle 812 such that claws 810 substantially surround the locking rod 106 and secure the support leg 104 to the base member 102. The support leg 104, in configurations, also has a release mechanism, as discussed above with regard to FIGS. 6-7, to release the support leg 104 from the locking rod 106.

FIG. 8 also illustrates a stopper 820 for implementation with rotatable claw mechanism 800. As shown, stopper 820 has an arm 822 extending from a base of the stopper 820. Stopper 820 also has a sliding end 823 that is structured to fit within a receiver 825 for the stopper 820. In configurations, the sliding end 823 is slidably coupled with the receiver 825, which is fixed to a portion of the support leg 104. The sliding end 823 of the stopper 820 is thus structured to allow the stopper 820 to translate along the length of the support leg, as described in further detail below. The arm 822, as shown in FIG. 8, fits around the barrel 815 of the rotatable claw mechanism 800 but does not directly contact the barrel 815 when the rotatable claw mechanism 800 is in an unlocked position.

As mentioned, the rotatable claw mechanism 800 is shown in the unlocked position in FIG. 8. With regard to the rotatable claw mechanism 800, the arm 822 of the stopper 820 extends into the receiving channel 818. In this way, when the support leg 104 is moved toward the locking rod 106 of the base member 102, the locking rod 106 will enter the receiving channel 818 and contact the arm 822 of the stopper 820. Applying a force will then cause the stopper 820 to translate and allow the claws 810 to rotate around the locking rod 106. This locking motion is described in further detail below.

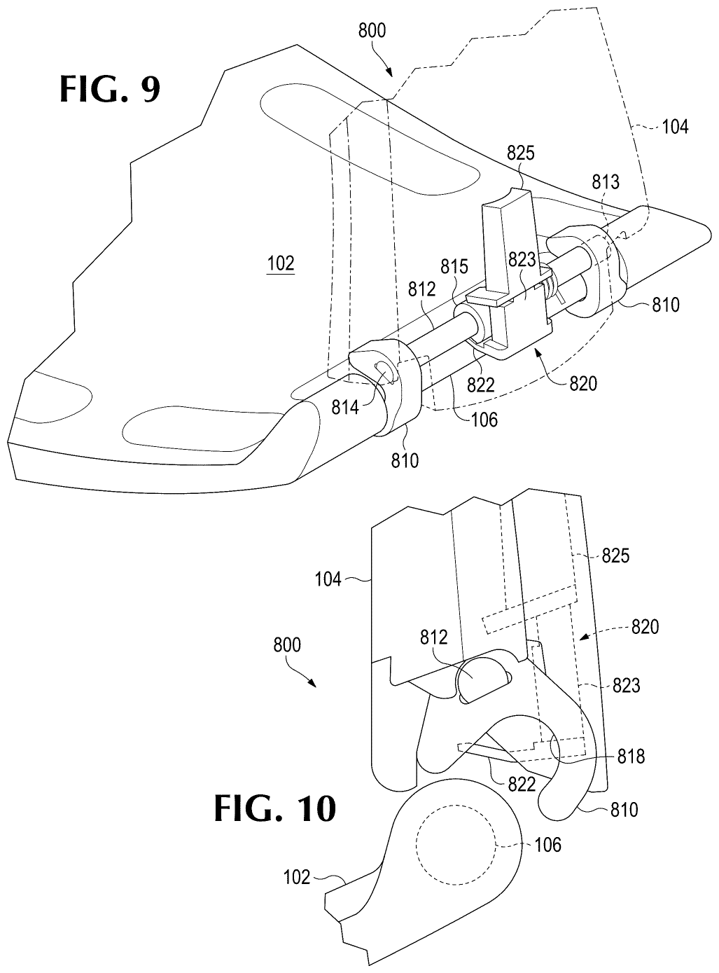

FIG. 9 is a cutaway, perspective view showing the rotatable claw mechanism 800 in the locked position, coupling the support leg 104 with the base member 102. In the locked position, the locking rod 106 is fully received in the receiving channel 818—shown in FIG. 9, as the channel is occupied by the locking rod 106—and the axle 812 of the rotatable claw mechanism 800 has rotated in a clockwise direction. It should be noted that reference to the clockwise direction is used as an example, with specific regard to the orientation depicted in FIG. 9. Reference to the clockwise direction thus should not be understood as limiting the rotational direction of the axle 812 in any way.

When the axle 812 has rotated to the locked position, the claws 810 rotate with the axle 812 and around the locking rod 106. In this way, the claws 810 substantially surround the locking rod 106 in the locked position. Furthermore, as shown in FIG. 9, the barrel 815 of the rotatable claw mechanism 800 has rotated with the axle 812. Although not illustrated in FIG. 9, when the barrel 815 is rotated to the locked position, a pin extending from the barrel also rotates, and a recess on the barrel 815 is exposed. Similar to the example described with regard to FIGS. 3-7, and as will be described in further detail below, the recess and pin of the barrel 815 work to hold the barrel 815 in the locked position. Finally, in the locked position, the stopper 820 is moved sufficiently away from its position in the receiving channel 818 of the rotatable claw mechanism 800 such that the locking rod 106 occupies the receiving channel 818.

FIG. 10 shows a side view of the rotatable claw mechanism 800 of FIGS. 8-9, in the unlocked position. As shown in more detail, and as previously mentioned, the arm 822 of the stopper 820 extends into the receiving channel 818. In this way, when the support leg 104 is moved toward the locking rod 106 of the base member 102, the locking rod 106 will enter the receiving channel enter the receiving channel 818 and contact the arm 822 of the stopper 820.

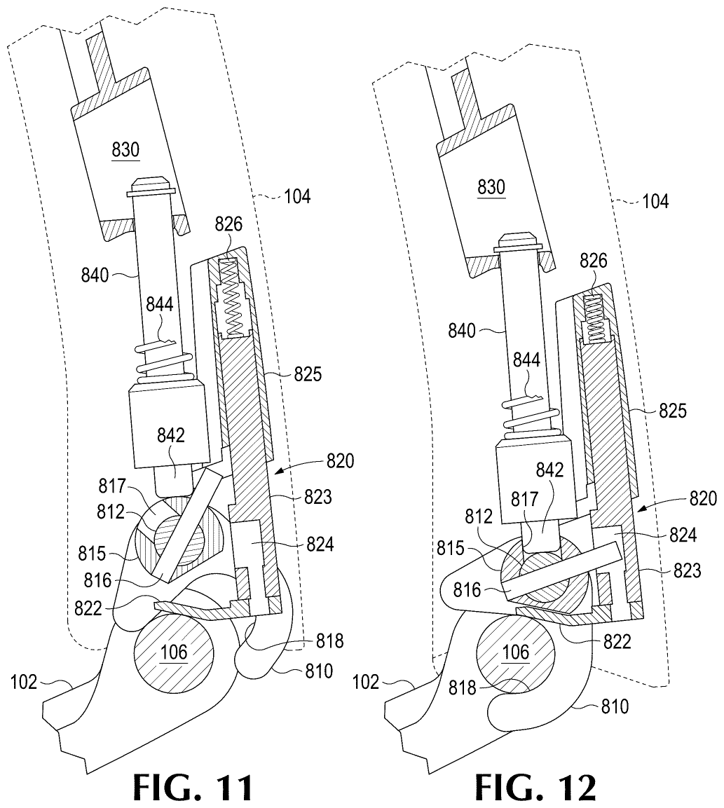

FIGS. 11-12 show the rotatable claw mechanism 800 of FIGS. 8-10 transitioning from the unlocked position to the locked position, further including internal components of the support leg 104. FIG. 11 shows the rotatable claw mechanism 800 initially in the unlocked position. As shown, the rotatable claw mechanism includes a pull rod 830 and a linking rod 840 positioned within the support leg 104, just as described with regard to the example shown in FIGS. 6-7. The pull rod 830 is coupled with the linking rod 840 such that the two translate together along the length of the support leg 104. Additionally, linking rod 840 includes an extension 842 and a biasing spring 844, which biases the linking rod 840 toward the barrel 815.

In the unlocked position, extension 842 of the linking rod 840 thus rests against the outer surface of the barrel 815. As shown, barrel 815 has a recess 817, and barrel 815 is positioned such that the recess 817 is not exposed to the extension 842 when in the unlocked position. Accordingly, the recess 817 does not receive the extension 842. Similarly, barrel 815 has a roll pin 816, and stopper 820 has a slot 824 for receiving the roll pin 816. However, in the unlocked position, roll pin 816 is not received in the slot 824. In configurations, roll pin 316 rests against the sliding end 823 of the stopper 820, directly above the slot 824, restricting any movement of the barrel 815. Furthermore, in the unlocked position, locking rod 106 of the base member 102 is not fully received in the receiving channel 818, and the arm 822 of the stopper 820 extends into the receiving channel 818.

As shown, the receiver 825 for the stopper 820 has a spring 826. Spring 826, in configurations, is fixed at an end of the receiver 825 opposite the arm 822 of the stopper 820, and the opposite end of the spring 826 is fixed to the sliding end 823 of the stopper 820. Receiver 825 is fixed within the support leg 104. Additionally, the receiver 825 is shaped such that the sliding end 823 is limited on two sides—namely, the sides along the length of the sliding end 823—and such that the sliding 823 translates with one degree of freedom within the receiver 825. Put differently, the sliding end 823 of the stopper 820 fits within the receiver 825 such that it slides in a direction along the length of the support leg 104 within the confines of the receiver 825. Due to the presence of spring 826, the stopper 820 is biased toward the unlocked position, wherein arm 822 extends within the receiving channel 818. When the stopper 820 translates upward, the spring 826 compresses and tends to bias the stopper 820 back toward the unlocked position.

As shown in FIG. 11, although the rotatable claw mechanism is in the unlocked position, the locking rod 106 is in contact with the stopper 820 to begin transitioning the mechanism from the unlocked position to the locked position. Because the stopper 820 is positioned to translate in the receiver 825, applying a force against the arm 822 of the stopper 820 causes such translation. In this way, the locking rod 106 contacting the arm 822 facilitates a force being applied and transitioning the mechanism to the locked position. Accordingly, a rescuer assembling the CPR device may apply the necessary force to cause the stopper 820 to translate within the receiver 825 by pressing the stopper 820 against the locking rod 106.

When the stopper 820 is pressed against the locking rod 106, the rotatable claw mechanism transitions to the locked position, shown in FIG. 12. Specifically, pressing the stopper 820 against the locking rod 106 causes the stopper 820 to translate upward along the length of the support leg 104 to compress spring 826. As stopper 820 translates upward, so do slot 824 and arm 822. Accordingly, arm 822 of the stopper 820 leaves its position in the receiving channel 818 when the stopper 820 is moved to the locked position, and therefore the stopper 820 is out of the way of the locking rod 106. The locking rod 106 then, in the locked position, occupies the space of the receiving channel 818 and is substantially surrounded by claws 810.

As previously discussed, in the unlocked position, roll pin 816 rests against the sliding end 823 of the stopper 820 and restricts movement of the barrel 815 and axle 812, in configurations. Consequently, when the stopper 820 translates upward along the length of the support leg 104, the slot 824 also translates upward, allowing the roll pin 816 to drop into the slot 824. Allowing the roll pin 816 to drop into the slot 824 in this way ultimately permits the barrel 815 and axle 812 to rotate and transition the mechanism from the unlocked position to the locked position. Once barrel 815 is free to rotate clockwise, barrel 815 rotates sufficiently to expose recess 817 to the extension 842 of the linking rod 840. Because the linking rod 840 is biased toward the barrel 815 by biasing spring 844, the extension 842 of the linking rod 840 drops into the recess 817 when the recess 817 is exposed. Thus, in the locked position, the extension 842 fits within the recess 817 and remains biased in this position by the biasing spring 844.

Furthermore, when the axle 812 is free to rotate, the claws 810 rotate with the axle 812. Accordingly, as axle 812 rotates such that roll pin 816 drops into the slot 824, claws 810 rotate to substantially surround locking rod 106 of the base member 102. With the claws 810 substantially surrounding the locking rod 106, the support leg 104 and base member 102 are coupled in the locked position.

Similar to the releasability described above with regard to FIGS. 6-7, rotatable claw mechanism 800 is releasable, in configurations. To release the support leg 104 and base member 102 from their coupling in the locked position in CPR devices implementing the rotatable claw mechanism 800, a rescuer may pull the pull rod 830. Although not illustrated in FIGS. 11-12, in configurations, pull rod 830 has a pull ring at an end opposite the linking rod 840, and the pull ring is external to the support leg 104 and thus accessible to the rescuer. In still other configurations, pull rod 830 has a tab, handle, or other suitable extension accessible to the rescuer and structured to pull the rod 830 along the length of the support leg 102 in a direction away from the base member 102. When pull rod 830 is pulled in such a direction, linking rod 840 translates with the pull rod 830 away from the base member 102. As linking rod 840 translates, the extension 842 lifts out of its position within the recess 817, freeing the barrel 815 to rotate.

Because stopper 820 is fixed within receiver 825 via spring 826, as mentioned, stopper 820 is biased toward the unlocked position, where the stopper 820 extends into the receiving channel 818. Accordingly, when extension 842 lifts out of recess 817 and frees barrel 815 to rotate, stopper 820 tends to translate back toward its unlocked position, and the slot 824 translates back downward with the stopper 820. As the slot 824 translates downward, roll pin 816 exits its position within slot 824. As previously mentioned, barrel 815 and axle 812 are also biased toward the unlocked position, and thus freeing the roll pin 816 from the slot 824 and freeing the barrel 815 to rotate causes barrel 815 and axle 812 to rotate counterclockwise to the unlocked position. As axle 812 rotates counterclockwise, claws 810 also rotate counterclockwise and accordingly release the locking rod 106 of the base member. With locking rod 106 no longer surrounded by claws 810, the support leg 104 can be lifted from the base member 102, returning the mechanism to the unlocked position, as described with regard to FIG. 11.

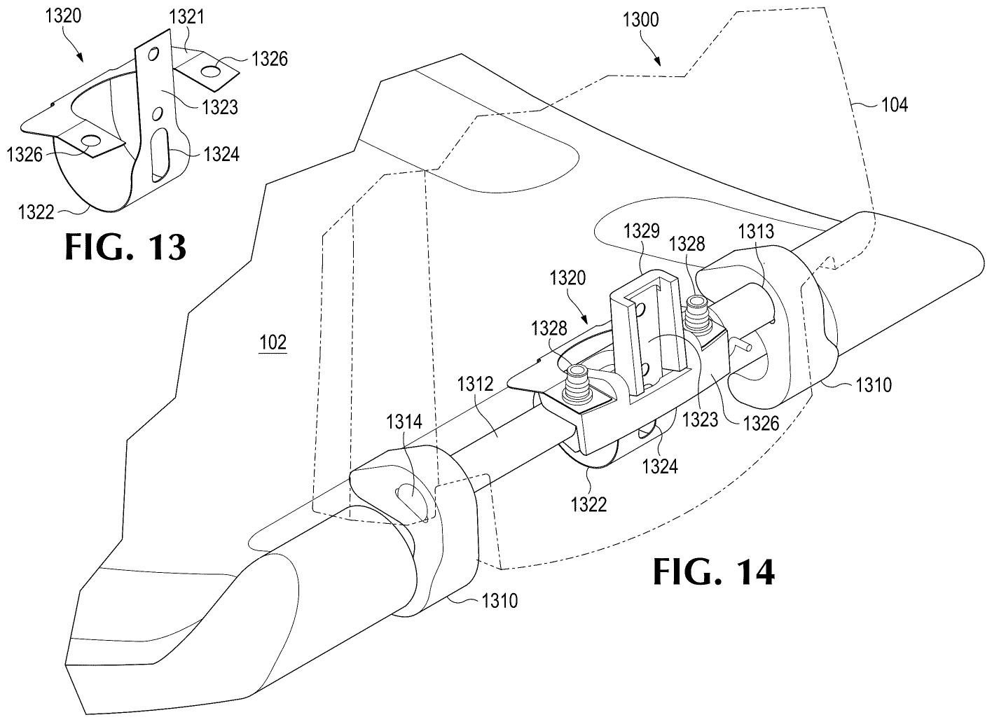

FIGS. 13-15 show details of a rotatable claw mechanism 1300 and a stopper 1320, according to an additional configuration of the disclosure. As discussed above with regard to FIGS. 3-12, rotatable claw mechanism 1300 and stopper 1320 can be implemented with a CPR device, such as the example shown in FIGS. 1-2. As shown in FIG. 14, rotatable claw mechanism 1300 is implemented to attach support leg 104 to base member 102 of a mechanical CPR device. Specifically, rotatable claw mechanism 1300 can be attached to locking rod 106 of the base member 102, which is at an end of the base member 102 at which support leg 104 meets and engages with the base member 102.

The rotatable claw mechanism 1300 may be coupled with the support leg 104, allowing the rotatable claw mechanism 1300 to be the point of interface between the support leg 104 and base member 102. Rotatable claw mechanism 1300, as shown in FIG. 14, has one or more claws 1310 positioned on an axle 1312, the axle 1312 allowing the one or more claws 1310 to rotate and engage with locking rod 106. In configurations, such as the example shown in FIG. 14, the rotatable claw mechanism 1300 has two claws 310, positioned at ends 1313, 1314 of the axle 1312, respectively.

In use, claws 1310 receive locking rod 106 when the support leg 104 and base member 102 are coupled, and rotatable claw mechanism 1300 locks the attachment between support leg 104 and base member 102, as described in further detail below. Just as described above with regard to FIGS. 3-12, claws 1310 of rotatable claw mechanism 1300 are structured to rotate with axle 1312 such that claws 1310 wrap around locking rod 106 and secure the support leg 104 to the base member. In some example configurations, a release mechanism is included in the support leg 104 to release rotatable claw mechanism 1300 from its engagement with locking rod 106, separating the support leg 104 from the base member 102.

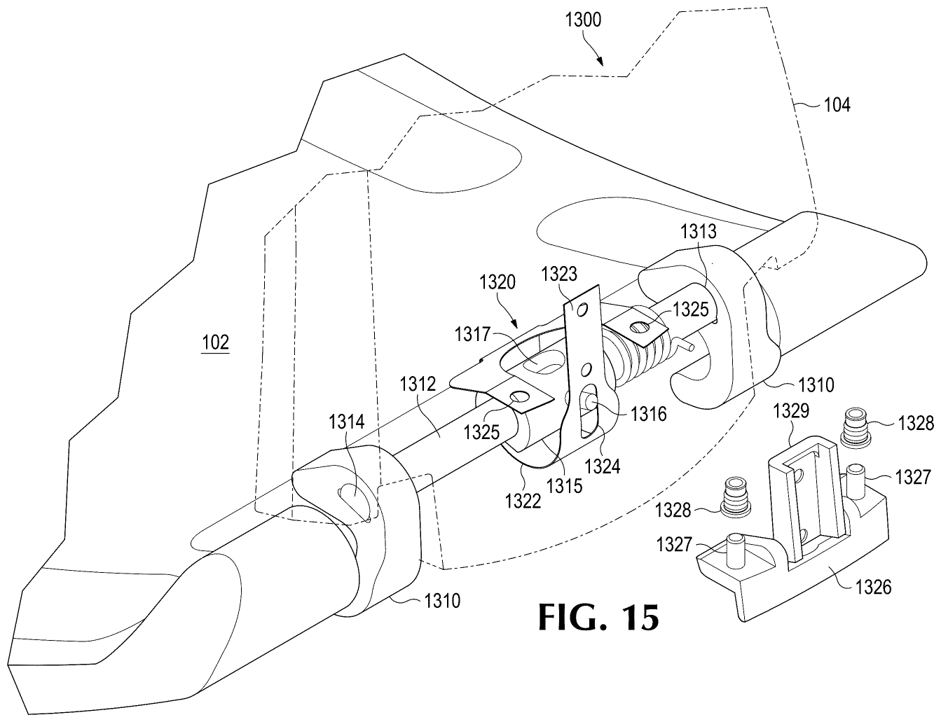

As shown in FIG. 15, rotatable claw mechanism 1300 also includes a barrel 1315 positioned on axle 1312. Barrel 1315 has a pin 1316 extending from a surface of barrel 1315, and barrel 1315 has a recess 1317 formed in a surface of barrel 1315. Barrel 1315 is configured to rotate with axle 1312, causing pin 1316 and recess 1317 to rotate such that each component contributes to the locking rotatable claw mechanism 1300 in the locked position. Further details of locking rotatable claw mechanism 1300 in the locked position are provided below.

FIG. 13 is a perspective view of stopper 1320, showing details of stopper 1320 according to configurations of the disclosure. Stopper 1320, similar to configurations described above with regard to FIGS. 3-12, has a curved portion 1322 and an elongated portion 1323. Additionally, a slot 1324 is cut from the material forming stopper 1320, in example configurations, and slot 1324 is shaped to receive the pin 1316 of rotatable claw mechanism 1300 when rotatable claw mechanism 1300 is in the locked position, described further below. Curved portion 1322 of stopper 1320, in configurations, fits around barrel 1315 of rotatable claw mechanism 1300 without directly contacting barrel 1315 when rotatable claw mechanism 1300 is in the unlocked position. In this way, similar to configurations described above with regard to FIGS. 3-12, curved portion 1322 of stopper 1320 must be pressed by locking rod 106, shifting slot 1324 to receive pin 1316, in order to deploy rotatable claw mechanism 1300 and move it to the locked position.

Different from configurations described above, stopper 1320 of FIG. 13 has an extension plate 1321, which extends from an end of curved portion 1322 toward elongated portion 1323. In this way, while previously described configurations have been described as being substantially J-shaped, stopper 1320 may be understood as being substantially P-shaped. As best shown in FIG. 13, extension plate 1321 also includes apertures 1325. Apertures 1325, in configurations, are structured to receive fasteners 1328, shown in FIGS. 14-15.

In configurations such as the example shown in FIG. 13, stopper 1320 is formed of a single piece of compliant sheet metal, such as steel. A piece of compliant sheet metal is thus cut in a shape corresponding to stopper 1320, and in some configurations, slot 1327 is further cut from within the shape. The cut piece of compliant sheet metal is then bent to form the substantially P-shape of stopper 1320, forming curved portion 1322, elongated portion 1323, and extension plate 1321 extending toward elongated portion 1323. Because stopper 1320 is formed to have curved portion 1322 and is made from compliant sheet metal, stopper 1320 thus acts as a spring. In other words, when extension plate 1321 is secured—such as with fasteners 1328 of FIGS. 14-15—applying a force to curved portion of stopper 1320 causes a portion of stopper 1320 to displace, causing stopper 1320 to have potential energy. When the force is removed, the potentially energy causes stopper 1320 to return to its original position before being displaced by the force.

As previously mentioned, an end of stopper 1320 can be secured or otherwise fixed at apertures 1325 of extension plate 1321. FIG. 15 shows additional details of a receiver 1326 structured to receive stopper 1320 and provide attachment points for stopper 1320. In particular, receiver 1326 has pegs 1327 extending from a surface of receiver 1326. Pegs 1327, in configurations, are structured to fit through apertures 1325 of stopper 1320. Once pegs 1327 are fit through apertures 1325, in this way, fasteners 1328 can be placed over pegs 1327 to secure extension plate 1321 to receiver 1326. In configurations, fasteners 1328 are mechanical fasteners, such as plugs, caps, or threaded nuts, structured to correspond with the geometry of pegs 1327.

As shown in FIG. 15, receiver 1326 also has a track 1329. Track 1329 is structured to receive elongated portion 1323 of stopper 1320, such that elongated portion 1323 is able to slide within track 1329 when a force is applied to stopper 1320. Put differently, when stopper 1320 is received in receiver 1326, one end of stopper 1320 is fixed via the attachment of extension plate 1321 at pegs 1327, while an opposite end of stopper 1320 is unfixed and therefore free to move.

When rotatable claw mechanism 1300 of FIGS. 13-15 is initially in the unlocked position, rotatable claw mechanism 1300 can be transitioned to the locked position by pressing stopper 1320 against the locking rod 106 of the base member 102. Because stopper 1320 is fixed at one end, via the attachment of extension plate 1321 at pegs 1327, but free to move at the elongated portion 1323, applying a force against the curved portion 1322 of stopper 1320 causes all portions of stopper 1320 excluding extension plate 1321 to translate away from the unlocked position. More specifically, elongated portion 1323 translates within track 1329 of receiver 1326, and curved portion 1322 deflects away from the channel in which locking rod 106 is to be received by claws 1310.

Just as described above with regard to FIGS. 3-12, when elongated portion 1323 translates within track 1329, slot 1324 also translates and moves to a position in which pin 1316 is free to enter slot 1324. That is, pin 1316 moves from resting against elongated portion 1323 in the unlocked position to entering slot 1324, allowing barrel 1315 and axle 1312 to rotate. As barrel 1315 and axle 1312 rotate, claws 1310 wrap around locking rod 106. Additionally, barrel 1315 rotates to expose recess 1317, which is then positioned to receive a linking rod of the support leg, as described above with regard to FIGS. 3-12, although not illustrated in FIGS. 13-15. With claws substantially surrounding locking rod 106, and with a linking rod received in recess 1317 of barrel 1315, the support leg 104 and base member 102 are coupled in the locked position. The rotatable claw mechanism 1300 may then be released using the same or similar methods described above with regard to FIGS. 3-6, by pulling a pull rod to remove the linking rod from recess 1317 and free barrel 1315 to rotate back to the unlocked position.

As disclosed herein, configurations of the rotatable claw mechanism may be considered always lockable from the unlocked position, as configurations of the rotatable claw mechanism can be deployed and locked without a rescuer needing to unlatch or reset any components of the mechanism. Rather, the rescuer need only apply a force to deploy various configurations of the rotatable claw mechanism, saving potentially valuable time in the rescue scenario. Additionally, configurations of the disclosed stopper prevent inadvertent locking of the rotatable claw mechanism by ensuring the rotatable claw mechanism only transitions into the locked position when the stopper is brought into contact with the locking rod.

### EXAMPLES

Illustrative examples of the disclosed technologies are provided below. A particular configuration of the technologies may include one or more, and any combination of, the examples described below.

Example 1 includes a cardiopulmonary resuscitation (“CPR”) device, comprising: a base member configured to be placed underneath a patient; a chest compression mechanism configured to deliver CPR chest compressions to a patient; a support leg configured to support the chest compression mechanism at a distance from the base member; a clamp mechanism coupled to the support leg and configured to attach the support leg to a lock component of the base member in a locked configuration of the clamp mechanism and to release the support leg from the lock component in a unlocked configuration of the clamp mechanism, the lock component of the base member being within a receiving channel of the clamp mechanism in the locked configuration; and a movable stopper comprising a strip-formed spring affixed to the support leg at a first end of the strip-formed spring, an opposite, second end of the strip-formed spring is configured to slide relative to the support leg, the strip-formed spring having resiliency, in a first configuration of the movable stopper, the movable stopper is configured to block movement of the clamp mechanism, thereby preventing the clamp mechanism from transitioning from the unlocked configuration to the locked configuration, a portion of the strip-formed spring is within the receiving channel of the clamp mechanism in the first configuration, in an second configuration of the movable stopper, the movable stopper is configured to not block movement of the clamp mechanism, thereby allowing the clamp mechanism to transition from the unlocked configuration to the locked configuration, the movable stopper is configured to move from the first configuration to the second configuration when the lock component of the base member is within the receiving channel of the clamp mechanism, the lock component displacing the strip-formed spring within the receiving channel of the clamp mechanism when the lock component of the base member is within the receiving channel, and the movable stopper is configured to move from the second configuration to the first configuration when the lock component of the base member is not within the receiving channel of the clamp mechanism.

Example 2 includes the CPR device of Example 1, in which the support leg comprises a channel, the strip-formed spring being configured to slide within the channel of the support leg when the movable stopper transitions between the first configuration and the second configuration.

Example 3 includes the CPR device of Example 2, the movable stopper further comprising a slider affixed to the second end of the strip-formed spring, the slider being configured to slide within the channel of the support leg and to contact at least two sidewalls of the channel of the support leg.

Example 4 includes the CPR device of any of Examples 1-3, in which the clamp mechanism includes: a shaft configured to rotate on a rotational axis of the shaft when the clamp mechanism transitions between the unlocked configuration and the locked configuration; and an arm extending away from the rotational axis of the shaft, the arm contacting the movable stopper in the first configuration to block movement of the arm in a first direction in the first configuration, thereby preventing transition of the clamp mechanism from the unlocked configuration to the locked configuration, the arm being positioned to enter a void of the movable stopper in the second configuration to permit movement of the arm in the first direction in the second configuration, thereby allowing transition of the clamp mechanism from the unlocked configuration to the locked configuration.

Example 5 includes the CPR device of Example 4, in which the void of the movable stopper is within the strip-formed spring.

Example 6 includes the CPR device of any of Examples 4-5, in which the void of the movable stopper translates between a first position in the first configuration and a second position in the second configuration.

Example 7 includes the CPR device of any of Examples 1-6, in which the movable stopper is configured to move from the first configuration to the second configuration due to a force imparted to the strip-formed spring by the lock component of the base member entering the receiving channel of the clamp mechanism.

Example 8 includes the CPR device of any of Examples 1-7, in which the movable stopper is configured to move from the second configuration to the first configuration because of the resiliency of the strip-formed spring as the lock component of the base member exits the receiving channel of the clamp mechanism.

Example 9 includes a cardiopulmonary resuscitation (“CPR”) device, comprising: a base member configured to be placed underneath a patient; a chest compression mechanism configured to deliver CPR chest compressions to a patient; a support leg configured to support the chest compression mechanism at a distance from the base member; a clamp mechanism coupled with the support leg and structured to move between an unlocked position and a locked position to secure the support leg to a locking rod of the base member, the clamp mechanism comprising: an axle configured to rotate about an axis substantially parallel to a long axis of the locking rod between the unlocked position and the locked position; one or more claws attached to the axle and structured to rotate with the axle between the unlocked position and the locked position, the one or more claws shaped to have a receiving channel structured to receive the locking rod of the base member; a barrel positioned on the axle and configured to rotate with the axle between the unlocked position and the locked position, the barrel having a pin extending from a first portion of the barrel; a movable stopper comprising a strip-formed spring slidably coupled with the support leg and configured to translate between a barred position and an unbarred position relative to the clamp mechanism, the movable stopper preventing the locking rod from being received in the receiving channel of the when the movable stopper is in the barred position, and the movable stopper allowing the locking rod to be received in the receiving channel when the movable stopper is in the unbarred position, the movable stopper further receiving the pin of the barrel in a slot when the movable stopper is in the unbarred position.

Example 10 includes the CPR device of Example 9, in which the support leg comprises a channel, the movable stopper being configured to slide within the channel of the support leg when the movable stopper translates between the barred position and the unbarred position.

Example 11 includes the CPR device of Example 10, the movable stopper further comprising a slider affixed to an end of the movable stopper, the slider being configured to slide within the channel of the support leg and to contact at least two sidewalls of the channel of the support leg.

Example 12 includes the CPR device of any of Examples 9-11, in which the pin contacts the movable stopper when the pin is in the unlocked position and the movable stopper is in the barred position, the pin preventing rotation of the barrel thereby preventing transition from the unlocked position to the locked position, the pin being further positioned to enter the slot of the movable stopper when the movable stopper is moved from the barred position to the unbarred position thereby allowing transition of the clamp mechanism from the unlocked position to the locked position.

Example 13 includes the CPR device of any of Examples 9-12, in which the movable stopper is configured to move from the barred position to the unbarred position when a force is applied to the movable stopper by the locking rod of the base member entering the receiving channel.

Example 14 includes the CPR device of any of Examples 9-13, in which the movable stopper has resiliency that biases the movable stopper to the barred position and causes the movable stopper to move from the unbarred position to the barred position when the locking rod of the base member exits the receiving channel.

Example 15 includes the CPR device of any of Examples 9-14, further comprising a linking rod disposed along a length of the support leg and a recess on a second portion of the barrel, the linking rod having an extension structured to fit within the recess of the barrel when the barrel is rotated to the locked position.

Example 16 includes the CPR device of Example 15, further comprising a pull rod coupled with linking rod, the pull rod structured to be pulled by a user to remove the extension from the recess of the barrel and transition the clamp mechanism from the locked position to the unlocked position.

Example 17 includes a cardiopulmonary resuscitation (“CPR”) device, comprising: a base member configured to be placed underneath a patient; a chest compression mechanism configured to deliver CPR chest compressions to a patient; a support leg configured to support the chest compression mechanism at a distance from the base member; a clamp mechanism coupled with the support leg and structured to move between an unlocked position and a locked position to secure the support leg to a locking rod of the base member, the clamp mechanism comprising: an axle configured to rotate about an axis substantially parallel to a long axis of the locking rod between the unlocked position and the locked position; one or more claws attached to the axle and structured to rotate with the axle between the unlocked position and the locked position, the one or more claws shaped to have a receiving channel structured to receive the locking rod of the base member; a barrel positioned on the axle and configured to rotate with the axle between the unlocked position and the locked position, the barrel having a pin extending from a first portion of the barrel; a movable stopper comprising a strip-formed spring slidably coupled with the support leg and configured to translate between a barred position and an unbarred position relative to the clamp mechanism, the movable stopper preventing the locking rod from being received in the receiving channel of the when the movable stopper is the barred position, and the movable stopper allowing the locking rod to be received in the receiving channel when the movable stopper is in the unbarred position, the movable stopper further receiving the pin of the barrel in a slot when the movable stopper is in the unbarred position; and a linking rod having an extension structured to fit within the recess of the barrel when the barrel is rotated to the locked position.

Example 18 includes the CPR device of Example 17, in which the support leg comprises a channel, the movable stopper being configured to slide within the channel of the support leg when the movable stopper translates between the barred position and the unbarred position.

Example 19 includes the CPR device of Example 18, the movable stopper further comprising a slider affixed to an end of the movable stopper, the slider being configured to slide within the channel of the support leg and to contact at least two sidewalls of the channel of the support leg.

Example 20 includes the CPR device of any of Examples 17-19, in which the pin contacts the movable stopper when the pin is in the unlocked position and the movable stopper is in the barred position, the pin preventing rotation of the barrel thereby preventing transition from the unlocked position to the locked position, the pin being further positioned to enter the slot of the movable stopper when the movable stopper is moved from the barred position to the unbarred position thereby allowing transition of the clamp mechanism from the unlocked position to the locked position.

Example 21 includes the CPR device of any of Examples 17-20, in which the movable stopper is a strip-formed spring having resiliency.

Example 22 includes the CPR device of any of Examples 17-21, in which the movable stopper is configured to move from the barred position to the unbarred position when a force is applied to the movable stopper by the locking rod of the base member entering the receiving channel.

Example 23 includes the CPR device of any of Examples 17-22, further comprising a pull rod coupled with linking rod, the pull rod structured to be pulled by a user to remove the extension from the recess of the barrel and transition the clamp mechanism from the locked position to the unlocked position.

Example 24 includes a method of assembling a cardiopulmonary resuscitation (“CPR”) device having a base member configured to be placed underneath a patient, a chest compression mechanism configured to deliver CPR chest compressions to a patient, and a support leg configured to support the chest compression mechanism at a distance from the base member, the method comprising the steps of: bringing the support leg, in an unlocked position, to the base member such that a movable stopper comprising a strip-formed spring slidably coupled with the support leg contacts a locking rod of the base member, the movable stopper barring the locking rod from being received in one or more claws of a rotatable claw mechanism of the support leg in an unlocked position; applying a force by the locking rod to cause the movable stopper to translate out of the receiving channel and unbar the locking rod from being received in the one or more claws of the rotatable claw mechanism.

Example 25 includes the method of Example 24, in which applying a force further causes a barrel of the rotatable claw mechanism having a pin and a recess to rotate from an unlocked position to a locked position.

Example 26 includes the method of Example 25, in which applying a force further causes the pin of the barrel to enter a slot of the movable stopper when the barrel rotates from the unlocked position to the locked position.

Example 27 includes the method of any of Examples 24-26, in which applying a force further causes a linking rod of the support leg to drop into the recess of the barrel when the barrel rotates from the unlocked position to the locked position.

Aspects may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various configurations. In addition, the functionality may be embodied in whole or in part in firmware or hardware equivalents such as integrated circuits, field programmable gate arrays (FPGA), and the like. Particular data structures may be used to more effectively implement one or more aspects of the disclosed systems and methods, and such data structures are contemplated within the scope of computer executable instructions and computer-usable data described herein.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the CPR device may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

We claim:

1. A cardiopulmonary resuscitation (“CPR”) device, comprising:
a base member configured to be placed underneath a patient;
a chest compression mechanism configured to deliver CPR chest compressions to a patient;
a support leg configured to support the chest compression mechanism at a distance from the base member;
a clamp mechanism coupled with the support leg and structured to move between an unlocked position and a locked position to secure the support leg to a locking rod of the base member, the clamp mechanism comprising:
an axle configured to rotate about an axis substantially parallel to a long axis of the locking rod between the unlocked position and the locked position;
one or more claws attached to the axle and structured to rotate with the axle between the unlocked position and the locked position, the one or more claws shaped to have a receiving channel structured to receive the locking rod of the base member;
a barrel positioned on the axle and configured to rotate with the axle between the unlocked position and the locked position, the barrel having a pin extending from a first portion of the barrel;
a movable stopper comprising a strip-formed spring slidably coupled with the support leg and configured to translate between a barred position and an unbarred position relative to the clamp mechanism, the movable stopper preventing the locking rod from being received in the receiving channel when the movable stopper is in the barred position, and the movable stopper allowing the locking rod to be received in the receiving channel when the movable stopper is in the unbarred position, the movable stopper further receiving the pin of the barrel in a slot when the movable stopper is in the unbarred position.

2. The CPR device of claim 1, in which a first end of the movable stopper is fixed to a portion of the support leg, and in which a second end of the movable stopper is configured to slide.

3. The CPR device of claim 2, in which the support leg comprises a channel, and in which the second end of the movable stopper is configured to slide within the channel of the support leg when the movable stopper translates between the barred position and the unbarred position.

4. The CPR device of claim 2, the movable stopper further comprising a slider affixed to an end of the movable stopper, the slider being configured to slide within the channel of the support leg and to contact at least two sidewalls of the channel of the support leg.

5. The CPR device of claim 1, in which the pin contacts the movable stopper when the pin is in the unlocked position and the movable stopper is in the barred position, the pin preventing rotation of the barrel thereby preventing transition from the unlocked position to the locked position, the pin being further positioned to enter the slot of the movable stopper when the movable stopper is moved from the barred position to the unbarred position thereby allowing transition of the clamp mechanism from the unlocked position to the locked position.

6. The CPR device of claim 1, in which the movable stopper is configured to move from the barred position to the unbarred position when a force is applied to the movable stopper by the locking rod of the base member entering the receiving channel.

7. The CPR device of claim 1, in which the movable stopper has resiliency that biases the movable stopper to the barred position and causes the movable stopper to move from the unbarred position to the barred position when the locking rod of the base member exits the receiving channel.

8. The CPR device of claim 1, further comprising a linking rod disposed along a length of the support leg and a recess on a second portion of the barrel, the linking rod having an extension structured to fit within the recess of the barrel when the barrel is rotated to the locked position.

9. The CPR device of claim 8, further comprising a pull rod coupled with linking rod, the pull rod structured to be pulled by a user to remove the extension from the recess of the barrel and transition the clamp mechanism from the locked position to the unlocked position.

10. A cardiopulmonary resuscitation (“CPR”) device, comprising:
a base member configured to be placed underneath a patient;
a chest compression mechanism configured to deliver CPR chest compressions to a patient;
a support leg configured to support the chest compression mechanism at a distance from the base member;
a clamp mechanism coupled with the support leg and structured to move between an unlocked position and a locked position to secure the support leg to a locking rod of the base member, the clamp mechanism comprising:
an axle configured to rotate about an axis substantially parallel to a long axis of the locking rod between the unlocked position and the locked position;
one or more claws attached to the axle and structured to rotate with the axle between the unlocked position and the locked position, the one or more claws shaped to have a receiving channel structured to receive the locking rod of the base member;
a barrel positioned on the axle and configured to rotate with the axle between the unlocked position and the locked position, the barrel having a pin extending from a first portion of the barrel;
a movable stopper comprising a strip-formed spring slidably coupled with the support leg and configured to translate between a barred position and an unbarred position relative to the clamp mechanism, the movable stopper preventing the locking rod from being received in the receiving channel when the movable stopper is the barred position, and the movable stopper allowing the locking rod to be received in the receiving channel when the movable stopper is in the unbarred position, the movable stopper further receiving the pin of the barrel in a slot when the movable stopper is in the unbarred position; and
a linking rod having an extension structured to fit within the recess of the barrel when the barrel is rotated to the locked position.

11. The CPR device of claim 10, in which the support leg comprises a channel, the movable stopper being configured to slide within the channel of the support leg when the movable stopper translates between the barred position and the unbarred position.

12. The CPR device of claim 11, the movable stopper further comprising a slider affixed to an end of the movable stopper, the slider being configured to slide within the channel of the support leg and to contact at least two sidewalls of the channel of the support leg.

13. The CPR device of claim 10, in which the pin contacts the movable stopper when the pin is in the unlocked position and the movable stopper is in the barred position, the pin preventing rotation of the barrel thereby preventing transition from the unlocked position to the locked position, the pin being further positioned to enter the slot of the movable stopper when the movable stopper is moved from the barred position to the unbarred position thereby allowing transition of the clamp mechanism from the unlocked position to the locked position.

14. The CPR device of claim 10, in which the movable stopper is configured to move from the barred position to the unbarred position when a force is applied to the movable stopper by the locking rod of the base member entering the receiving channel.

15. The CPR device of claim 10, in which the movable stopper has resiliency that biases the movable stopper to the barred position and causes the movable stopper to move from the unbarred position to the barred position when the locking rod of the base member exits the receiving channel.

16. The CPR device of claim 10, further comprising a pull rod coupled with linking rod, the pull rod structured to be pulled by a user to remove the extension from the recess of the barrel and transition the clamp mechanism from the locked position to the unlocked position.

17. A method of assembling a cardiopulmonary resuscitation (“CPR”) device having a base member configured to be placed underneath a patient, a chest compression mechanism configured to deliver CPR chest compressions to a patient, and a support leg configured to support the chest compression mechanism at a distance from the base member, the method comprising the steps of:
bringing the support leg, in an unlocked position, to the base member such that a movable stopper comprising a strip-formed spring slidably coupled with the support leg contacts a locking rod of the base member, the movable stopper barring the locking rod from being received in one or more claws of a rotatable claw mechanism of the support leg in an unlocked position;
applying a force by the locking rod to cause the movable stopper to translate out of the receiving channel and unbar the locking rod from being received in the one or more claws of the rotatable claw mechanism.

18. The method of claim 17, in which applying a force further causes a barrel of the rotatable claw mechanism having a pin and a recess to rotate from an unlocked position to a locked position.

19. The method of claim 18, in which applying a force further causes the pin of the barrel to enter a slot of the movable stopper when the barrel rotates from the unlocked position to the locked position.

20. The method of claim 18, in which applying a force further causes a linking rod of the support leg to drop into the recess of the barrel when the barrel rotates from the unlocked position to the locked position.
